(19) United States
(12) Patent Application Publication
(10) Pub. No.: US 2025/0140939 A1
(43) Pub. Date: May 1, 2025

(54) LEAKAGE ELECTROLYTE DETECTION DEVICE AND DETECTION METHOD

(71) Applicant: SAMSUNG SDI CO., LTD., Yongin-si (KR)

(72) Inventors: Ha Kyu LEE, Yongin-si (KR); Hyunjong CHUNG, Yongin-si (KR); Juheon YU, Yongin-si (KR); Jihyang PARK, Yongin-si (KR); Hahyun CHOI, Yongin-si (KR); Sunuk HWANG, Yongin-si (KR)

(21) Appl. No.: 18/752,482

(22) Filed: Jun. 24, 2024

(30) Foreign Application Priority Data
Oct. 31, 2023 (KR) 10-2023-0148298

(51) Int. Cl. H01M 10/42; G01M 3/04; G06T 7/00; G06V 10/30; G06V 10/58; H01M 10/48

(52) U.S. Cl. CPC H01M 10/4228; G01M 3/04; G06T 7/0002; G06V 10/58; H01M 10/48; G06V 10/30

(57) ABSTRACT

A leakage electrolyte solution detection device includes a hyperspectral imaging device, an image extractor, and a determination unit. The hyperspectral imaging device includes an optical unit that collects reflected light by scanning a rechargeable battery on which the electrolyte solution injection process has been completed, a dispersive element that disperses light processed by the optical unit, and an image sensor that converts the light dispersed by the dispersive element into an electric signal, and acquires a hyperspectral image of a rechargeable battery. The image extractor extracts an image of a band related to a characteristic wavelength of an electrolyte solution from the hyperspectral image. The determination unit determines a presence or absence of a leakage electrolyte solution by analyzing the image extracted by the image extractor.

### CROSS-REFERENCE TO RELATED APPLICATION

The present application claims priority to and the benefit of Korean Patent Application No. 10-2023-0148298, filed on Oct. 31, 2023, in the Korean Intellectual Property Office, the entire content of which is hereby incorporated by reference.

### BACKGROUND

### 1. Field

Embodiments of the present disclosure relate to a manufacturing technology of rechargeable batteries. For example, embodiments of the present disclosure relate to a device for detecting a leakage electrolyte solution and a detection method.

### 2. Description of the Related Art

A rechargeable battery generally includes an electrode assembly, a case that accommodates the electrode assembly, and a cap assembly that seals the case. An electrolyte injection opening is on (e.g., through) the cap assembly, and after a liquid electrolyte solution is injected into the case, the electrolyte injection opening is sealed. Afterwards, the rechargeable battery goes through a formation process (a process that activates the battery to make it electrically charged) before being shipped as a product.

When injecting the electrolyte solution, the electrolyte solution may fall onto the cap assembly and stain the cap assembly surface. Before the rechargeable battery with completed electrolyte solution injection is put into the formation process, it is inspected for leakage of an electrolyte solution using a visual inspection device including a region scan camera. Because the electrolyte solution has similar components to the cleaning solution, however, it is difficult to distinguish between the electrolyte solution and the cleaning solution during the inspection process, thereby resulting in a plurality of inspection errors.

### SUMMARY

Embodiments of the present disclosure provide a leakage electrolyte solution detection device and a detection method that may quickly and accurately determine a leakage electrolyte solution in a liquid state that has fallen on the cap assembly and thereby reduce inspection errors.

A leakage electrolyte solution detection device according to an embodiment includes a hyperspectral imaging device, an image extractor, and a determination unit. The hyperspectral imaging device includes an optical unit that collects reflected light by scanning a rechargeable battery on which the electrolyte solution injection process has been completed, a dispersive element that disperses light processed by the optical unit, and an image sensor that converts the light dispersed by the dispersive element into an electric signal, and acquires a hyperspectral image of a rechargeable battery. The image extractor extracts an image of a band related to a characteristic wavelength of an electrolyte solution from the hyperspectral image. The determination unit determines a presence or absence of a leakage electrolyte solution by analyzing the image extracted by the image extractor.

The leakage electrolyte solution detection device may further include a transferring unit that moves the rechargeable battery below the hyperspectral imaging device, and a halogen lamp that radiates light to the rechargeable battery that passes under the hyperspectral imaging device.

The image extractor may generate a band ratio image using the characteristic wavelength of the electrolyte solution and the band ratio of surrounding wavelengths. The image extractor may use a filtering function when extracting the image to remove noise from the band ratio image.

The determination unit may include a secondary differentiation performing unit that performs secondary differentiation of a spectrum curved line of the band ratio image, a calculator that calculates a coefficient value of a measured liquid from the result of the secondary differentiation, and a comparison analysis unit that determines whether an electrolyte solution is present by comparing the absolute value of the calculated coefficient value with a set or predetermined threshold value.

The calculator may calculate the coefficient value by dividing the characteristic wavelength band in which the reaction of the measured liquid is distinguished by the surrounding wavelength band in which the reaction is indistinguishable.

The comparison analysis unit may set an arbitrary secondary differential reaction value that may distinguish the cleaning solution and the remaining solutions from the results of secondary differential reaction values for each of the electrolyte solution, the cleaning solution, and a plurality of mixed solutions as a threshold value before the inspection of the rechargeable battery. The comparison analysis unit may determine a measured liquid as the electrolyte solution when the absolute value of the coefficient value is equal to or greater than the threshold value, and determines the measured liquid as the cleaning solution when the absolute value of the coefficient value is less than the threshold value.

A leakage electrolyte solution detection method according to an embodiment includes: image acquisition including acquiring a hyperspectral image of a rechargeable battery by using a hyperspectral imaging device; image extraction including extracting an image of a band related to the characteristic wavelength of the electrolyte solution from the hyperspectral image; and determination including determining whether the measured liquid is an electrolyte solution by secondary differentiation of a spectrum curved line of the extracted image, calculating a coefficient value of a measured liquid, and comparing an absolute value of the coefficient value and a size of a threshold value.

In the image extraction, a band ratio image may be extracted using a band ratio of the characteristic wavelength of the electrolyte solution and surrounding wavelengths. The determination may include: secondary differentiation of the spectrum curved line of the band ratio image; calculating the coefficient value of the measured liquid from the result of the secondary differentiation; comparing the absolute value of the calculated coefficient value and the size of the threshold value; and determining the measured liquid as the electrolyte solution when the absolute value of the coefficient value is equal to or greater than the threshold value.

The coefficient value may be calculated by dividing the characteristic wavelength band in which the reaction of the measured liquid is distinguished by the surrounding wavelength band in which the reaction is indistinguishable. The threshold value may be set as an arbitrary secondary differential reaction value that can distinguish the cleaning solution and the remaining solutions from the results of secondary differential reaction values for each of the electrolyte solution, the cleaning solution, and a plurality of mixed solutions before the inspection of the rechargeable battery.

According to the leakage electrolyte solution detection device and the detection method according to the embodiment, for rechargeable batteries in which the electrolyte solution injection has been completed, the leakage electrolyte solution in the liquid state may be quickly and accurately determined and inspection errors may be reduced. Therefore, the production efficiency of the rechargeable batteries may be improved.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic perspective view of a leakage electrolyte solution detection device according to an embodiment.

FIG. 2 is a schematic diagram showing an example embodiment of a hyperspectral imaging device among a leakage electrolyte solution detection device shown in FIG. 1.

FIG. 3 is a graph showing spectrum characteristics of two types (or kinds) of an electrolyte solution, a cleaning solution, and a cap plate.

FIG. 4 is a view showing an example of a hyperspectral raw image of a cap plate of a rechargeable battery acquired by an image sensor.

FIG. 5 is a view showing an example of a band ratio image of a cap plate of a rechargeable battery generated by an image extractor.

FIG. 6 is a view showing an example of a final image of a cap plate of a rechargeable battery after noise filtering.

FIG. 7 is a graph showing spectrum characteristics of each of an electrolyte solution, a cleaning solution, mixed solutions 1 to 5, and a cap plate.

FIG. 8 is a graph showing a result of secondary differentiation of a spectrum curved line shown in FIG. 7.

FIG. 9 is a flowchart showing an operation process of a determination unit among a leakage electrolyte solution detection device shown in FIG. 1.

FIG. 10 is a schematic diagram showing a configuration of a determination unit among a leakage electrolyte solution detection device shown in FIG. 1.

FIG. 11 is a flowchart showing a leakage electrolyte solution detection method according to an embodiment.

FIG. 12 is a view showing examples of hyperspectral raw images of cap plates of rechargeable batteries for four types (or kinds) of targets to be detected and detection result images by a post process.

### DETAILED DESCRIPTION

The subject matter of the present disclosure will be described more fully hereinafter with reference to the accompanying drawings, in which embodiments of the present disclosure are shown. As those skilled in the art would realize, the described embodiments may be modified in various suitable different ways, all without departing from the spirit or scope of the present disclosure.

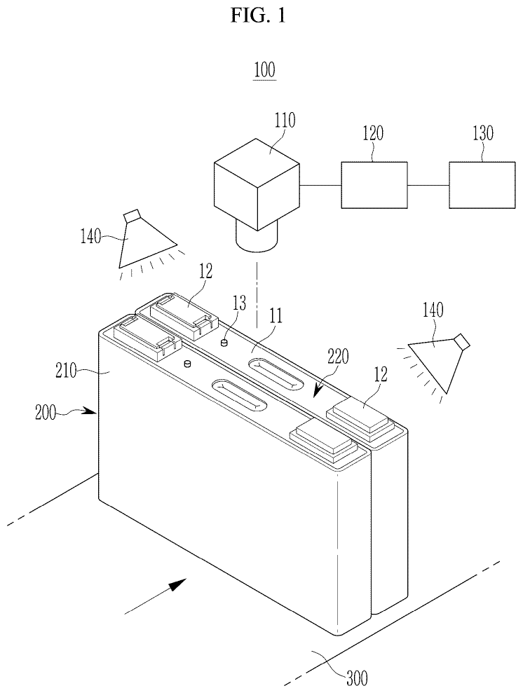

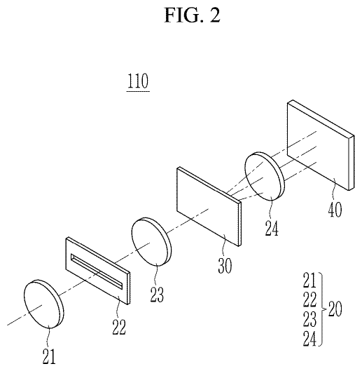

FIG. 1 is a schematic perspective view of a leakage electrolyte solution detection device according to an embodiment. FIG. 2 is a schematic diagram showing an example of a hyperspectral imaging device among a leakage electrolyte solution detection device shown in FIG. 1.

Referring to FIG. 1 and FIG. 2, a leakage electrolyte solution detection device 100 of the present embodiment inspects a rechargeable battery 200 injected with an electrolyte solution by using hyperspectral imaging (HSI) to determine a presence or absence of a leakage electrolyte solution in a liquid state.

In more detail, the leakage electrolyte solution detection device 100 may include a hyperspectral imaging device 110 that acquires a hyperspectral image of the rechargeable battery 200 that is an inspection target, an image extractor 120 that extracts an image of a band related to the characteristic wavelength of the electrolyte solution, and a determination unit 130 that determines the presence or absence of the leakage electrolyte solution.

The leakage electrolyte solution detection device 100 may further include a light 140 that irradiates light to a rechargeable battery 200.

The rechargeable battery 200 may include a case 210, an electrode assembly stored inside the case 210 along with an electrolyte solution, and a cap assembly 220 that is coupled to the end of the case 210 and seals the case 210. The rechargeable battery 200 may be classified into various suitable shapes such as cylindrical, prismatic, and pouch-type depending on the appearance thereof. In FIG. 1, a square rechargeable battery is shown as an example, but the present disclosure is not limited thereto.

The cap assembly 220 may include a cap plate 11 and at least one terminal 12. The electrolyte injection opening may be positioned on (e.g., through) the cap plate 11, and then sealed by the cap 13 after the electrolyte solution is injected into the case 210. The electrolyte solution may fall on the cap plate 11 and stick to the cap plate 11 during the injection process, and this leakage electrolyte solution is not easily erased.

The leakage electrolyte solution detection device 100 may determine the presence or absence of the leakage electrolyte solution in a liquid state by inspecting the cap assembly 220 of the rechargeable battery 200 in which the electrolyte solution injection has been completed. The hyperspectral imaging device 110 and the light 140 are positioned above the rechargeable battery 200 and may maintain the fixed positions. In embodiments, the rechargeable battery 200, which is the inspection target, may be placed on a transferring unit 300 and may move in one direction by the operation of the transferring unit 300.

In FIG. 1, two rechargeable batteries 200 are shown for convenience, but a plurality of rechargeable batteries may be provided side by side on the transferring unit 300 so that they may sequentially pass under the hyperspectral imaging device 110. The hyperspectral imaging device 110, the light 140, and the rechargeable battery 200 may be surrounded by a chamber and isolated from the external environment.

The light 140 may include or consist of a lamp that emits light including ultraviolet rays, for example, a halogen lamp. A typical light emitting diode (LED) lamp emits light in a relatively narrow wavelength range. In embodiments, the halogen lamp emits light having a wide wavelength range, from ultraviolet rays to mid-wavelength infrared rays, and are therefore suitable for a light of the hyperspectral imaging device 110.

The hyperspectral imaging adds a spectral technology to spatial information and is a technology that derives a state, a composition, a feature, and a transformation of a target object by organizing two-dimensional image information according to a spectrum band of an electromagnetic wave in a form of a hyperspectral cube.

A color camera or a human eye may also recognize a color or state of an object by acquiring spectrum information of red, green, and blue, respectively, so it may be called spectral imaging, but normal spectral imaging has a larger number of spectrum bands. If the number of the spectrum bands is less than 10, it may be classified as multi-spectral imaging, if it has more than 100, it may be classified as hyperspectral imaging, and if it has more than 1000, it may be classified as ultra-hyper-spectral imaging.

The hyperspectral imaging device 110 may include an optical unit 20 (FIG. 2), a dispersive element 30, and an image sensor 40. The optical unit 20 may include a front lens 21, an entrance slit 22, a collimator 23, and a focusing lens 24, and it is not limited to this example. The dispersive element 30 may be between the collimator 23 and the focusing lens 24, and the image sensor 40 may be behind the focusing lens 24.

The front lens 21 accepts the reflected light of the rechargeable battery 200 and forms a first image. The light passing through the front lens 21 becomes parallel light through the entrance slit 22 and the collimator 23, and the parallel light is dispersed for each wavelength at the dispersive element 30. The light dispersed for the wavelength reaches the image sensor 40 through the focusing lens 24, and is converted into an electric signal at the image sensor 40.

The dispersive element 30 may be classified into a monochromator method using a prism or a lattice, a fixed variable filter method using a filter wheel or a Fabry-Perot interference filter, etc., and a variable tunable filter method using a liquid crystal tunable filter (LCTF) or an acousto-optic tunable filter (AOTF).

The prism disperses incident light by using the difference in a wavelength progression speed and a movement path of light according to the refractive index. The lattice uses the diffraction and interference phenomenon of light to disperse the incident light for each wavelength. The filter wheel includes or consists of a rotating wheel equipped with a plurality of filters. The Fabry-Perot interference filter uses a principle that when light of multiple wavelengths enters the filter, a plurality of interferences occur in a resonance layer, and light of only certain wavelengths is transmitted and the rest is reflected.

The liquid crystal tunable filter is a structure in which liquid crystal plates having different thicknesses are between a plurality of polarizers, and uses a principle of changing a transmission wavelength by changing a direction of an arrangement of liquid crystal molecules through current changes. The acousto-optic tunable filter uses a principle of forming perturbations of a certain frequency in a crystalline material through vibration of a piezoelectric transducer, and passing only a certain wavelength through the interaction of the perturbation with photons of incident light.

The image sensor 40 may be composed of a two-dimensional (2D) image sensor, and may be equipped with a plurality of image sensors depending on the optical unit 20 and a measurement spectrum band. FIG. 2 shows one image sensor 40. A plurality of image sensors can be used with a beam splitter.

The electrolyte solution of the rechargeable battery 200 may include an electrolyte salt and a solvent, and may additionally include various suitable types (or kinds) of additives. The electrolyte salt may include phosphoric acid lithium hexafluoride (LiPF₆), and the solvent may include one selected from ethylene carbonate (EC), ethyl methyl carbonate (EMC), and dimethyl carbonate (DMC).

All (or almost all) materials that exist on earth have a property of absorbing light of a set or specific wavelength, and the electrolyte solution also has the property of absorbing light of a set or specific wavelength. Hereinafter, a maximum absorption wavelength of the electrolyte solution is referred to as ‘a characteristic wavelength’ of the electrolyte solution. When inspecting the presence or absence of the leakage electrolyte solution dropped on the cap plate 11 in the liquid state, it must be possible to distinguish between the electrolyte solution and a cleaning solution.

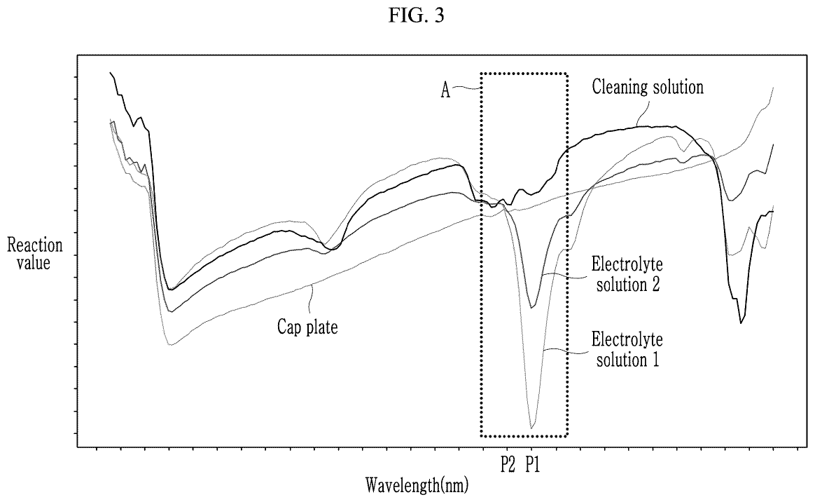

FIG. 3 is a graph showing spectrum characteristics of two types (or kinds) of electrolyte solution, a cleaning solution, and a cap plate. The horizontal axis of the graph represents the wavelength, and the vertical axis represents the reaction value for each wavelength band, and the reaction value. The electrolyte solution 1 includes less of the solvent than the electrolyte solution 2, and the cleaning solution includes dimethyl carbonate (DMC).

Referring to FIG. 3, the spectrum characteristics of each of the cap plate and the cleaning solution show a clear difference from the spectrum characteristics of the electrolyte solutions 1 and 2. The electrolyte solutions 1 and 2 have the characteristic of absorbing light in a set or specific wavelength band. In FIG. 3, P1 represents the characteristic wavelength of the electrolyte solution, and P2 represents the surrounding wavelength. The surrounding wavelength P2 is located close to the characteristic wavelength P1 and is a wavelength at which no reaction occurs with other solutions.

Referring to FIG. 1 to FIG. 3, the image extractor 120 may be electrically connected to the controller that processes the information from the image sensor 40, and may extract the image of the band related to the characteristic wavelength of the electrolyte solution from the hyperspectral image acquired by the image sensor 40. When the electrolyte solution of the liquid state exists on the cap plate 11, the image generated by the image extractor 120 may display the leakage electrolyte solution of the liquid state.

To increase the inspection speed of the leakage electrolyte solution, the image sensor 40 may acquire hyperspectral images in a selected wavelength range that includes the characteristic wavelength of the electrolyte solution. The selected wavelength band refers to a wavelength band that includes an arbitrary range smaller than P1 and an arbitrary range larger than P1, centered around the characteristic wavelength P1 of the electrolyte solution. The wavelength band indicated by A in FIG. 3 may correspond to the selected wavelength band.

In embodiments, the image extractor 120 may generate a band ratio image using the band ratio of the characteristic wavelength P1 of the electrolyte solution and the surrounding wavelength P2 to increase the visibility of the leakage electrolyte solution. The image extractor 120 may include a filtering function to remove noise. Increasing the inspection speed of the rechargeable batteries may cause a plurality of noises, so using the filtering function, the inspection speed of rechargeable batteries may be increased and concurrently (e.g., simultaneously) inspection errors may be minimized or reduced.

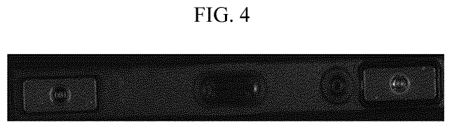

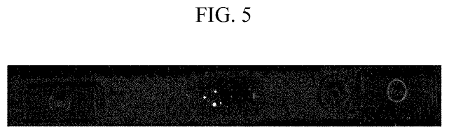

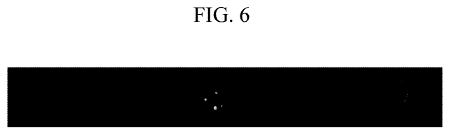

FIG. 4 is a view showing an example of a hyperspectral raw image acquired by an image sensor. FIG. 5 is a view showing an example of a band ratio image generated by an image extractor. FIG. 6 is a view showing an example of a final image after noise filtering.

In the hyperspectral raw image in FIG. 4, the approximate composition of the cap assembly is confirmed, and no leakage electrolyte solution is recognized. In the band ratio image of FIG. 5, white dots represent the leakage electrolyte solution in the liquid state. In the final image in FIG. 6, it may be confirmed that the noise has been removed and only the leakage electrolyte solution is clearly expressed.

Referring to FIG. 1, the determination unit 130 may determine the presence or absence of the leakage electrolyte solution by analyzing the band ratio image generated by the image extractor 120, for example, the band ratio image from which the noise has been removed, using a set or predetermined reference. The rechargeable battery 200 determined to be good by the determination unit 130 may move to the formation process, and the rechargeable battery 200 determined to be defective may be discarded.

In embodiments, as shown in FIG. 3, when the cleaning solution is dimethyl carbonate (DMC), the electrolyte solution and the cleaning solution show clear differences in the spectrum characteristics, but when the cleaning solution is pure water (deionized water) and the electrolyte solution and the pure water are mixed, various suitable mixed solutions having different purity contents coexist, it may be difficult to distinguish the mixed solution and the cleaning solution. In addition to the electrolyte solution, all mixed solutions including even small amounts of the electrolyte solution components must be determined as the same reference as the electrolyte solution.

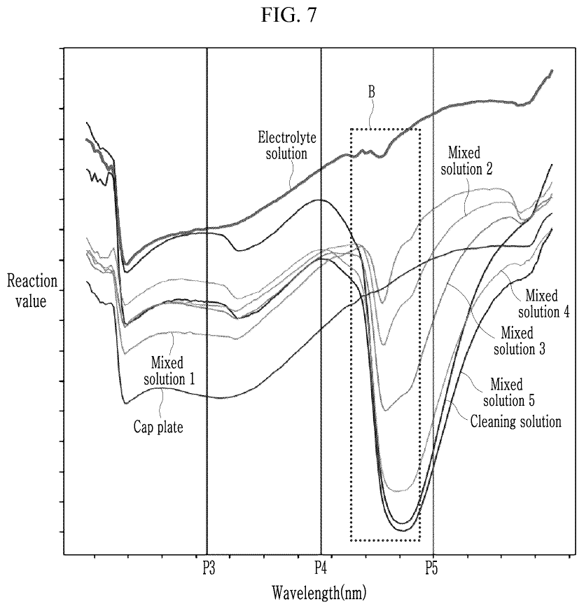

FIG. 7 is a graph showing spectrum characteristics of an electrolyte solution, a cleaning solution, mixed solutions 1 to 5, and a cap plate. The cleaning solution is pure water, and mixing ratios of the electrolyte solution and the cleaning solution in the mixed solutions 1 to 5 is as shown in Table 1.

TABLE 1

| | Mixed | Mixed | Mixed | Mixed | Mixed |
|---|---|---|---|---|---|
| | solution | solution | solution | solution | solution |
| | 1 | 2 | 3 | 4 | 5 |
| Electrolyte | 9:1 | 7:3 | 5:5 | 3:7 | 1:9 |
| solution:cleaning | | | | | |
| solution | | | | | |

In FIG. 7, a region B represents a region where the characteristic wavelengths of the electrolyte solution, the cleaning solution, and the mixed solutions 1 to 5 are gathered. The electrolyte solutions of the various compositions are used in the rechargeable batteries. The composition of the electrolyte solution used in the spectrum analysis in FIG. 7 is different from the composition of the electrolyte solution used in the spectrum analysis in FIG. 3.

Referring to FIG. 7, there is a clear difference between the spectrum characteristic of the electrolyte solution and the spectrum characteristic of the cleaning solution, and as the content of the cleaning solution in the mixed solutions 1 to 5 is higher, the spectrum characteristic thereof becomes difficult to distinguish from the spectrum characteristic of the cleaning solution. For example, the spectrum characteristic of the mixed solution 5 is extremely similar to that of the cleaning solution in the region B. All mixed solutions 1 to 5 must be identified as the electrolyte solutions in the determination unit.

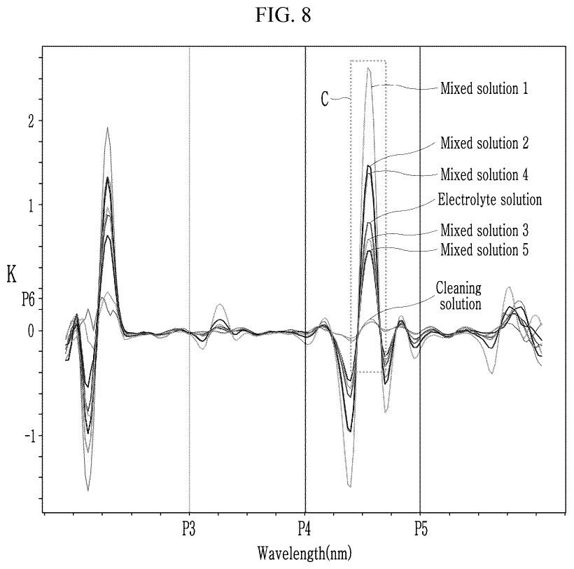

FIG. 8 is a graph showing a result of secondary differentiation of a spectrum curved line shown in FIG. 7. In FIG. 8, the horizontal axis represents the wavelength, and the vertical axis represents the secondary differentiation reaction value (K). P3, P4, and P5 indicated on the horizontal axis of FIG. 7 and FIG. 8 are arbitrary reference values and represent set or predetermined specific values.

Referring to FIG. 8, in the region C, the secondary differentiation reaction value of the cleaning solution is clearly distinguished from the secondary differentiation reaction value of the mixed solutions 1 to 5, and, for example, there is also a clear difference from the secondary differentiation reaction value of the mixed solution 5. Through the secondary differentiation conversion of this spectrum characteristic it is possible to clearly distinguish between the cleaning solution and the mixed solution 5, in which it is difficult to distinguish between the characteristics in the spectrum pattern of FIG. 7. In embodiments, the ability to distinguish between the cleaning solution and the mixed solution 5 may be improved by using the secondary differential transformation.

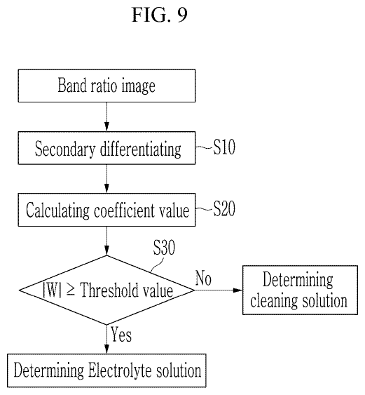

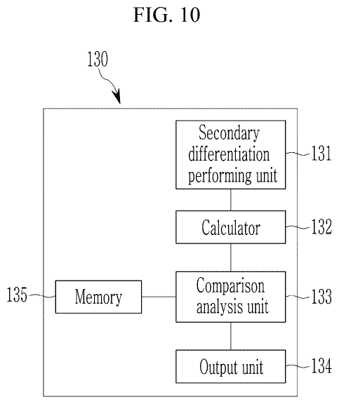

FIG. 9 is a flowchart showing an operation process of a determination unit among a leakage electrolyte solution detection device shown in FIG. 1. FIG. 10 is a schematic diagram showing a configuration of a determination unit.

Referring to FIG. 9 and FIG. 10, the determination process of the leakage electrolyte solution through the determination unit may include a first act (S10) in which secondary differentiation is performed from a spectrum curved line of a band ratio image generated by an image extractor, a second act (S20) in which a coefficient value of a measured liquid is calculated from the result of the secondary differentiation, and a third act (S30), which compares the absolute value of the calculated coefficient value with a set or predetermined threshold value and determines the measured liquid as an electrolyte solution when the absolute value of the coefficient value is equal to or greater than the threshold value.

The determination unit 130 may include a secondary differentiation performing unit 131 for performing the secondary differentiation of the first act (S10), a calculator 132 for calculating the coefficient value of the second act (S20), a comparison analysis unit 133 for comparison analysis of the third act (S30), and an output unit 134 for outputting the comparison result of the comparison analysis unit 133.

Before the leakage electrolyte solution detection device operates, the threshold value may be stored in advance in a memory 135 of the determination unit 130. The threshold value means a set or specific secondary differential reaction value that may distinguish the cleaning solution and the remaining solution (both the electrolyte solution and the various suitable types (or kinds) of the mixed solutions) from the pattern of the secondary differential reaction values for each of the electrolyte solution, the cleaning solution, and the various suitable types (or kinds) of the mixed solutions.

P6 indicated on the vertical axis of FIG. 8 may be set as the threshold value. P6 is larger than the secondary differential reaction value of the cleaning solution observed in the region C of FIG. 8, and smaller than the secondary differential reaction value of the mixed solution 5. For example, P6 may be a reference to distinguish the cleaning solution from the remaining solutions (the electrolyte solution and the mixed solutions 1 to 5).

In the second act (S20), the calculator 132 calculates the coefficient value W of the measured liquid. The calculator 132 may calculate the coefficient value by dividing the characteristic wavelength band in which the reaction of the measured liquid is distinguished by the surrounding wavelength band in which the reaction is indistinguishable. The calculated coefficient value corresponds to a peak value of lines observed in the region C of FIG. 8.

In the third act (S30), the comparison analysis unit 133 compares the absolute value of the coefficient value calculated in the second act (S20) with the threshold value stored in the memory. If the absolute value of the coefficient value is equal to or greater than the threshold value, the measured liquid is determined to be the electrolyte solution, and if the absolute value of the coefficient value is less than the threshold value, the measured liquid is determined to be the cleaning solution. According to the decision result of the output unit 134, the rechargeable battery whose measured liquid is determined to be the cleaning solution is moved to the formation process, and the rechargeable battery whose measured liquid is determined to be the electrolyte solution is collected.

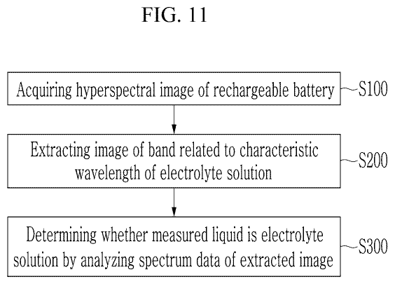

FIG. 11 is a flowchart showing a leakage electrolyte solution detection method according to an embodiment.

Referring to FIG. 11, a leakage electrolyte solution detection method of the present embodiment may include an image acquisition act (S100) of acquiring a hyperspectral image of a rechargeable battery from a hyperspectral imaging device, an image extraction act (S200) in which an image of a band related to the characteristic wavelength of the electrolyte solution is extracted from the image extractor, and an electrolyte solution determination act (S300) of determining whether the measured liquid is the electrolyte solution by analyzing the spectrum data of the image extracted from the determination unit.

Referring to FIG. 1 and FIG. 2, in the image acquisition act (S100), the hyperspectral imaging device 110 may include the optical unit 20, the dispersive element 30, and the image sensor 40, and may acquire the hyperspectral image of the rechargeable battery 200 to be inspected. FIG. 4 shows an example of the hyperspectral raw image acquired by the image sensor.

In the image extraction act (S200), the image extractor 120 may generate the band ratio image by using the characteristic wavelength of the electrolyte solution and the band ratio of the surrounding wavelengths to increase the visibility of the leakage electrolyte solution, and the noise from the band ratio image may be removed using the filtering function. FIG. 5 shows an example of the band ratio image generated by the image extractor, and FIG. 6 shows an example of the final image that has undergone the noise filtering.

Referring to FIG. 9 and FIG. 10, the electrolyte solution determination act (S300) may include the first act (S10) in which the secondary differentiation is performed from the spectrum curved line of the band ratio image generated by the image extractor 120, the second act (S20) in which the coefficient value of the measured liquid is calculated from the result of the secondary differentiation, and the third act S30, which compares the absolute value of the calculated coefficient value with a set or predetermined threshold value and determines the measured liquid as the electrolyte solution if the absolute value of the coefficient value is equal to or greater than the threshold value.

Details of the electrolyte solution determination act (S300) are the same as the content described above with reference to FIG. 9 and FIG. 10, so that redundant explanations may not be repeated here. The determination unit 130, which operates through the above-described process, may quickly and accurately determine the electrolyte solution and the cleaning solution, and may reduce inspection errors, thereby increasing the production efficiency of the rechargeable batteries.

Table 2 shows results of detection consistency experiments by using the leakage electrolyte solution detection device according to the present embodiment. For the detection consistency experiments, an electrolyte solution, a cleaning solution, a contamination (a marker), and a scratch defect, which are larger than 1 mm in size were randomly generated on a rechargeable battery, and measurements were repeated 10 times for the same cell (the rechargeable battery).

TABLE 2

| Detection target | Cell / defect number | Consistency result |
|---|---|---|
| Electrolyte solution | 6 cells / 60 | 100% (detection) |
| Cleaning solution | 2 cells / 20 | 100% (no detection) |
| Contamination (marker) | 1 cell / 10 | 100% (no detection) |
| Scratch | 1 cell / 10 | 100% (no detection) |

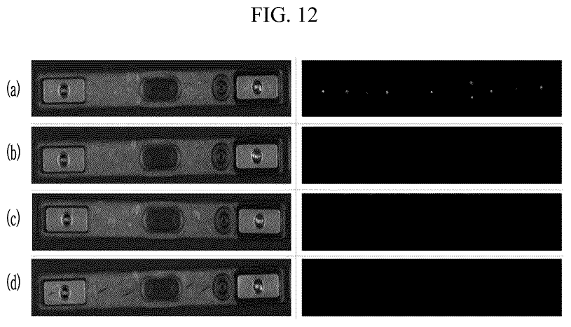

FIG. 12 is a view showing examples of hyperspectral raw images for four types (or kinds) of targets to be detected described in Table 2 and detection result images by a post process. FIG. 12(a), (b), (c), and (d) show rechargeable batteries in which the electrolyte solution, the cleaning solution, the contamination (the marker), and the scratch defects are generated. Referring to Table 2 and FIG. 12, for four different types (or kinds) of defects, it may be confirmed that the electrolyte solution contamination was detected with 100% consistency, excluding the cleaning solution, the contamination (the marker), and scratch defects.

While the subject matter of this disclosure has been described in connection with what is presently considered to be practical example embodiments, it is to be understood that the present disclosure is not limited to the disclosed embodiments, but, on the contrary, is intended to cover various suitable modifications and equivalent arrangements included within the spirit and scope of the appended claims, and equivalents thereof.

What is claimed is:

1. A leakage electrolyte solution detection device comprising:
a hyperspectral imaging device comprising an optical unit that collects reflected light by scanning a rechargeable battery on which the electrolyte solution injection process has been completed, a dispersive element that disperses light processed by the optical unit, and an image sensor that converts the light dispersed by the dispersive element into an electric signal, and acquires a hyperspectral image of a rechargeable battery;
an image extractor that extracts an image of a band related to a characteristic wavelength of an electrolyte solution from the hyperspectral image; and
a determination unit that determines a presence or absence of a leakage electrolyte solution by analyzing the image extracted by the image extractor.

2. The leakage electrolyte solution detection device of claim 1, further comprising:
a transferring unit that moves the rechargeable battery below the hyperspectral imaging device; and
a halogen lamp that radiates light to the rechargeable battery that passes under the hyperspectral imaging device.

3. The leakage electrolyte solution detection device of claim 1, wherein:
the image extractor generates a band ratio image using the characteristic wavelength of the electrolyte solution and the band ratio of surrounding wavelengths.

4. The leakage electrolyte solution detection device of claim 3, wherein:
the image extractor uses a filtering function when extracting the image to remove noise from the band ratio image.

5. The leakage electrolyte solution detection device of claim 3, wherein:
the determination unit comprises:
a secondary differentiation performing unit that performs secondary differentiation of a spectrum curved line of the band ratio image;
a calculator that calculates a coefficient value of a measured liquid from the result of the secondary differentiation; and
a comparison analysis unit that determines whether an electrolyte solution is present by comparing the absolute value of the calculated with a set threshold value.

6. The leakage electrolyte solution detection device of claim 5, wherein:
the calculator calculates the coefficient value by dividing the characteristic wavelength band in which the reaction of the measured liquid is distinguished by the surrounding wavelength band in which the reaction is indistinguishable.

7. The leakage electrolyte solution detection device of claim 5, wherein:
the comparison analysis unit sets an arbitrary secondary differential reaction value that may distinguish the cleaning solution and the remaining solutions from the results of secondary differential reaction values for each of the electrolyte solution, the cleaning solution, and a plurality of mixed solutions as a threshold value before the inspection of the rechargeable battery.

8. The leakage electrolyte solution detection device of claim 5, wherein:
the comparison analysis unit determines a measured liquid as the electrolyte solution when the absolute value of the coefficient value is equal to or greater than the threshold value, and determines the measured liquid as the cleaning solution when the absolute value of the coefficient value is less than the threshold value.

9. A leakage electrolyte solution detection method, the method comprising:
image acquisition comprising acquiring a hyperspectral image of a rechargeable battery by using a hyperspectral imaging device;
image extraction comprising extracting an image of a band related to the characteristic wavelength of the electrolyte solution from the hyperspectral image; and
determination comprising determining whether the measured liquid is an electrolyte solution by secondary differentiation of the spectrum curved line of the extracted image, calculating a coefficient value of a measured liquid, and comparing the absolute value of the coefficient value and the size of the threshold value.

10. The leakage electrolyte solution detection method of claim 9, wherein:
in the image extraction, a band ratio image is extracted using a band ratio of the characteristic wavelength of the electrolyte solution and surrounding wavelengths.

11. The leakage electrolyte solution detection method of claim 9, wherein:
the determination comprises:
secondary differentiating the spectrum curved line of the band ratio image;
calculating the coefficient value of the measured liquid from the result of the secondary differentiation; and
comparing the absolute value of the calculated coefficient value and the size of the threshold value, and determining the measured liquid as the electrolyte solution when the absolute value of the coefficient value is equal to or greater than the threshold value.

12. The leakage electrolyte solution detection method of claim 11, wherein:
the coefficient value is calculated by dividing the characteristic wavelength band in which the reaction of the measured liquid is distinguished by the surrounding wavelength band in which the reaction is indistinguishable.

13. The leakage electrolyte solution detection method of claim 11, wherein:
the threshold value is set as an arbitrary secondary differential reaction value that can distinguish the cleaning solution and the remaining solutions from the results of secondary differential reaction values for each of the electrolyte solution, the cleaning solution, and a plurality of mixed solutions before the inspection of the rechargeable battery.
